(19) United States
(12) Patent Application Publication
(10) Pub. No.: US 2008/0156720 A1
(43) Pub. Date: Jul. 3, 2008

(54) CHRYSANTHEMUM-SHAPED ELEMENT AND METHOD FOR MANUFACTURING THE SAME, FILTER BODY AND FLUID FILTER

(75) Inventor: Yoshihiro OHASHI, Aichi-ken (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 11/954,404

(22) Filed: Dec. 12, 2007

(30) Foreign Application Priority Data
Dec. 29, 2006 (JP) 2006-356802

(51) Int. Cl. B01D 29/21; B32B 23/08; B32B 23/12

(52) U.S. Cl. 210/442; 156/62.2; 210/493.2

(57) ABSTRACT

The chrysanthemum-shaped element is in a cylindrical shape in which folds are formed and inner surfaces of adjacent folds are bonded at their top and bottom edges. The chrysanthemum-shaped element includes (A) an element body composed of a filter medium having a filter paper and a low-melting fiber layer formed on a surface of the filter paper on the inner surface side of the folds at least at the top and bottom edges of the filter paper; and (B) bonding sections formed at the top and bottom edges on inner surfaces of the folds by heat-adhesion of the low-melting fiber layer. The low-melting fiber layer is made of a fiber having a lower melting point than that of filter paper materials that form the filter paper and/or compound fibers which contain a fiber of a lower melting point than that of the filter paper material.

### BACKGROUND OF THE INVENTION

1. Field of the Invention

The present invention relates to a chrysanthemum-shaped element and a method for manufacturing the same, a filter body and a fluid filter. More particularly, the present invention relates to a chrysanthemum-shaped element and a method for manufacturing the same, a filter body and a fluid filter which do not require application of adhesives to a filter medium, take full advantage of the original filtration area of the filter medium, and are superior in filter efficiency and filter life.

2. Description of the Related Art

Conventionally, as a filter body used for a general fluid filter, for example, (1) a filter body having a chrysanthemum-shaped element formed by applying adhesives in neighboring areas of a top edge and a bottom edge of a strip-shaped filter paper, being folded into a cylindrical chrysanthemum shape, and thereafter by bonding the top edges and the bottom edges between folds (see Patent Document 1); (2) a chrysanthemum-shaped element formed by applying hot-melt adhesives at a top edge and a bottom edge of a strip-shaped filter paper, being folded into a cylindrical chrysanthemum shape, and thereafter by bonding the top edges and the bottom edges between folds (see Patent Document 2); (3) a cylindrical filter of multi-layered non-woven fabrics composed of a plurality of spunbonded non-woven fabrics being wound and the adjacent non-woven fabrics being heat-sealed (see Patent Document 3); and (4) a cylindrical filter formed on a porous cylindrical body by winding in a twill form a strip-shaped non-woven fabric containing a thermoplastic fiber and heat-bonding a part of the non-woven fabric (see Patent Document 4) are known.

In view of application of filter products, since the expansion of an effective area of a filter paper leads to expansion of a product life, an area of bonding section of filter medium on filter medium where filtration performance is not available is desirable to be as small as possible. However, in a production of the chrysanthemum-shaped elements described in Patent Documents 1 and 2 above, to ensure oil-tightness to prevent a leakage of unfiltered oil from a filter body, a process of applying adhesives at a top edge and a bottom edge of a filter medium where folds are formed is required. With hot-melt adhesives used in their production, as the control of the area where the hot-melted adhesives spread is difficult, it entails that bonding areas at the top and bottom edges of the filter medium take up wider than necessary, resulting in not making full use of the original filtration area of the filter medium, and an improvement in filter performance is desired.

In order to secure an effective filtration area as large as possible, the closer to the edges the bonding positions at the top and bottom edges the more desirable. However, in the production of the chrysanthemum-shaped element described in Patent Document 1, when a application position of adhesives is set too close to the edges, as the adhesives seep out from the top and bottom edges while bonding between folds, troubles of the element getting affixed to a production line may occur. Consequently, it requires application of adhesives to neighboring areas of the top and bottom edges, not making full use of the original filtration area of the element.

Meanwhile, in the cylindrical filters described in Patent Documents 3 and 4 above, as fibers are heat-sealed, a process of applying adhesives is not required. However, as fibers themselves which function as a filter medium are heat-sealed not making full use of the original filtration area of the filter medium and as the control of heat-sealed area is not easy, a part of the fibers which are supposed to function as a filter medium may get heat-sealed more than necessary. There have been problems in that consistently maintaining high filtration accuracy is not possible.

Patent Document 1: Japanese Patent Application Publication No. JP-A-2003-181212

Patent Document 2: Japanese Patent Application Publication No. JP-A-H10-57716

Patent Document 3: Japanese Patent Application Publication No. JP-A-2006-150222

Patent Document 4: Japanese Patent Application Publication No. JP-A-2001-29717

### SUMMARY OF THE INVENTION

### Problems to be Solved by the Invention

In light of the circumstances described above, it is an object of the present invention to provide a chrysanthemum-shaped element and a method for manufacturing the same, a filter body and a fluid filter which do not require application of adhesives to a filter medium, take full advantage of the original filtration area of the filter medium, and are superior in filter efficiency and filter life.

### Means for Solving Problem

The present invention is described as follows.

1. A chrysanthemum-shaped element in a cylindrical shape in which folds are formed and inner surfaces of adjacent folds are bonded at a top edge and a bottom edge thereof, said chrysanthemum-shaped element comprising:

(A) an element body composed of a filter medium;
said filter medium comprising:
   a filter paper; and
   a low-melting fiber layer formed on a surface of said filter paper on the inner surface side of said folds at least at said top edge and said bottom edge of said filter paper; and

(B) bonding sections formed at said top and bottom edges on the inner surfaces of said folds by heat-adhesion of said low-melting fiber layer;

wherein said low-melting fiber layer is formed of at least one of a fiber of a lower melting point than that of a filter paper material with which said filter paper is formed and compound fibers containing a fiber of a lower melting point than that of said filter paper material.

2. The chrysanthemum-shaped element according to 1. above, wherein said low-melting fiber layer is formed on the entire surface of said filter paper on the inner surface side of said folds.
3. The chrysanthemum-shaped element according to 1. above, wherein the diameter of said fiber with which said low-melting fiber layer is formed is from 0.1 to 10 μm.
4. The chrysanthemum-shaped element according to 1. above, wherein the thickness of said low-melting fiber layer is from 20 to 50% of that of said filter paper.
5. The chrysanthemum-shaped element according to 1. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
6. The chrysanthemum-shaped element according to 2. above, wherein the diameter of said fiber with which said low-melting fiber layer is formed is from 0.1 to 10 μm.
7. The chrysanthemum-shaped element according to 2. above, wherein the thickness of said low-melting fiber layer is from 20 to 50% of that of said filter paper.
8. The chrysanthemum-shaped element according to 2. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
9. The chrysanthemum-shaped element according to 3. above, wherein the thickness of said low-melting fiber layer is from 20 to 50% of that of said filter paper.
10. The chrysanthemum-shaped element according to 3. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
11. The chrysanthemum-shaped element according to 4. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
12. The chrysanthemum-shaped element according to 6. above, wherein the thickness of said low-melting fiber layer is from 20 to 50% of that of said filter paper.
13. The chrysanthemum-shaped element according to 6. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
14. The chrysanthemum-shaped element according to 7. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
15. The chrysanthemum-shaped element according to 9. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
16. The chrysanthemum-shaped element according to 12. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
17. A method for manufacturing a chrysanthemum-shaped element according to 1. above, the method comprising:

forming, on a surface of a filter paper at least at a top edge and a bottom edge thereof, a low-melting fiber layer composed of at least one of a fiber of a lower melting point than that of a filter paper material with which said filter paper is formed and compound fibers containing a fiber of a lower melting point than that of said filter paper material; and

folding said filter paper on which said low-melting fiber layer is formed into a cylindrical chrysanthemum shape so that the surface of said filter paper on which said low-melting fiber layer is formed is on inner sides of folds, and bonding said top edge and said bottom edge of said folds with heat-adhesion of said low-melting fiber layer by heating up said top edge and said bottom edge of said folds.

18. The method for forming a chrysanthemum-shaped element according to 17. above, wherein in forming said low-melting fiber layer, at least one of a melt-blow method and a spunbond method is used to form said low-melting fiber layer on the surface of said filter paper.
19. A filter body comprising:

said chrysanthemum-shaped element according to 1. above; and

seal sections formed on a top surface and a bottom surface of said chrysanthemum-shaped element.

20. A fluid filter comprising:

said filter body according to 19. above;

a housing that houses said filter body; and

a top support and a bottom support that are provided in said housing and that support said filter body in the upward and downward directions;

wherein seal sections of said filter body seal spaces between both end surfaces in an axial direction of said chrysanthemum-shaped element of said filter body and said top support and said bottom support.

21. The fluid filter according to 20. above, wherein said low-melting fiber layer is formed on the entire surface of said filter paper on the inner surface side of said folds.
22. The fluid filter according to 20. above, wherein the diameter of said fiber with which said low-melting fiber layer is formed is from 0.1 to 10 μm.
23. The fluid filter according to 20. above, wherein the thickness of said low-melting fiber layer is from 20 to 50% of that of said filter paper.
24. The fluid filter according to 20. above, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

### EFFECT OF THE INVENTION

In the chrysanthemum-shaped element according to an aspect of the present invention, a bonding section of folds is formed by heat-adhesion of the low-melting fiber layer, and thus a bonded area can be made to a bare minimum. Accordingly, the chrysanthemum-shaped element can take full advantage of the original filtration area of the filter medium, and is superior in filter efficiency and filter life.

When the low-melting fiber layer is formed on the entire surface of inner sides of the folds of the filter paper, the low-melting fiber layer except for the area where heat-adhesion is applied (the bonding section) serves as a filter medium. Therefore, the filter efficiency of the chrysanthemum-shaped element is further improved and the filter life is extended longer.

When the diameter of fibers with which the low-melting fiber layer is formed is from 0.1 to 10 μm, the filter efficiency of the chrysanthemum-shaped element is further improved and the filter life is extended longer.

When the thickness of the low-melting fiber layer is from 20 to 50% of that of the filter paper, top edges and bottom edges of inner surfaces of the folds of the chrysanthemum-shaped element are reliably bonded. Furthermore, the filter efficiency of the chrysanthemum-shaped element is further improved and the filter life is extended longer.

When filter paper materials with which a filter paper is formed are composed of at least one of cellulose fibers and polyethylene terephthalate fibers, and the low-melting fiber layer is composed of at least one of polypropylene fibers and compound fibers containing polypropylene fibers, the filter efficiency of the chrysanthemum-shaped element is surely improved and the filter life is extended longer.

In the method for manufacturing the chrysanthemum-shaped element according to another aspect of the present invention, the low-melting fiber layer formed on the surface of the filter paper can be used as a bonding material for inner surfaces of the folds and the control of the bonding area is easy. Therefore, top edges and bottom edges of the folds can be bonded in a bare minimum area, and the chrysanthemum-shaped element having a large effective filtration area is easily produced. Also, a process of applying adhesives to a filter medium in the related art can be eliminated, and thus the time required for the production of the chrysanthemum-shaped element can be shortened.

In addition, when the low-melting fiber layer is formed by a melt-blow method or a spunbond method, the low-melting fiber layer composed of fibers of a fine diameter is easily formed.

The filter body according to still another aspect of the present invention is superior in filter efficiency and filter life, as the aforementioned chrysanthemum-shaped element is provided.

The fluid filter according to still another aspect the present invention is superior in filter efficiency and filter life, as the aforementioned chrysanthemum-shaped element is provided.

Therefore, the fluid filter is widely applicable to the field of fluid filters such as an oil filter used for automobiles and the like and to the field of gas filters such as an air filter used as a component of an air cleaner installed in an inlet system of an internal-combustion engine.

### BRIEF DESCRIPTION OF THE DRAWINGS

FIG. 1 is a half sectional side view of an oil filter of a first embodiment of the present invention;

FIG. 2 is a plan view of a filter body of the first embodiment;

FIG. 3 is a half sectional side view of the filter body of the first embodiment;

FIG. 4 is a plan view of a chrysanthemum-shaped element of the first embodiment;

FIG. 5 is a half sectional side view of the chrysanthemum-shaped element of the first embodiment;

FIG. 6 is a half sectional side view of a chrysanthemum-shaped element of a second embodiment;

FIG. 7 is a half sectional side view of a chrysanthemum-shaped element of a third embodiment;

FIG. 8 is an illustration of a heating jig; and

FIG. 9 is an illustration showing a method for manufacturing the chrysanthemum-shaped element of the first embodiment.

### DESCRIPTION OF REFERENCE NUMERALS AND SIGNS

1; oil filter, 2; casing, 4; relief valve, 5; check valve, 10; filter body, 11,21,31; chrysanthemum-shaped element, 12a; top surface, 12b; bottom surface, 14,15; seal section, 16,26,36; fold, 17a,27a,37a; top edge bonding section, 17b,27b,37b; bottom edge bonding section, 37c; other bonding section, and X; heating jig.

### DETAILED DESCRIPTION OF THE PREFERRED EMBODIMENTS

Here, specific instances of preferred embodiments of the present invention are described in details.

### (1) Chrysanthemum-Shaped Element

A chrysanthemum-shaped element of the present invention is in a cylindrical shape in which folds are formed and inner surfaces of adjacent folds are bonded at their top edges and bottom edges. The chrysanthemum-shaped element includes (A) an element body composed of a filter medium having a filter paper and a low-melting fiber layer which is formed on a surface of the filter paper on inner surface side of the folds at least at the top edge and the bottom edge of the filter paper; and (B) bonding sections formed at the top and bottom edges on inner surfaces of the folds by heat-adhesion of the low-melting fiber layer.

The element body above is composed of a filter medium having a filter paper and a low-melting fiber layer formed on the surface of the filter paper at least at the top edge and the bottom edge of the filter paper.

As for filter paper materials with which the filter paper above is formed, materials of a melting point of 170° C. or higher are desirable, while those of from 180 to 300° C. are more desirable, and those of from 230 to 300° C. are further desirable. For materials that thermally decompose rather than melt, such as cellulose fibers, the above temperature ranges may be replaced with decomposition temperatures.

More specifically, cellulose fibers such as pulp fibers, linter fibers and rayon fibers, polyethylene terephthalate (PET) fibers, acrylic fibers, polyvinyl alcohol fibers, and polyamide synthetic fibers are conceivable. Among these, the cellulose fibers and PET fibers are desirable.

Note that these fibers may be used in a single kind or in a mixture of 2 or more kinds.

The fiber diameter of the filter paper materials is desirable to be from 1 to 60 μm, and from 5 to 50 μm is more desirable.

The thickness of the filter paper is desirable to be from 0.4 to 1.2 mm, while from 0.5 to 1.1 mm is more desirable, and from 0.6 to 1.0 mm is further desirable. The thickness of the filter paper being from 0.4 to 1.2 mm provides an adequate filtration performance.

The low-melting fiber layer above is formed on the surface of the filter paper at least at its top edge and bottom edge. Particularly, the low-melting fiber layer is desirable to be formed on the entire surface of the filter paper. In this case, as the low-melting fiber layer except for the areas where heat-adhesion is applied at the top and bottom edges (bonding sections) serves as a filter medium, the filter efficiency of the chrysanthemum-shaped element is further improved and the filter life is extended longer.

Note that the surface of the filter paper here represents an inner side surface of folds of the chrysanthemum-shaped element of the present invention. A top-and-bottom direction of the surface of a filter paper corresponds to the top-and-bottom direction of an axial direction of the chrysanthemum-shaped element.

The low-melting fiber layer is formed by fibers of a lower melting point than that of the filter paper materials with which the filter paper is formed (also called low-melting fibers, hereinafter) and/or compound fibers containing the low-melting fibers. More specifically, the low-melting fiber layer is formed with at least one of the low-melting fibers and compound fibers containing the low-melting fibers.

As for the low-melting fibers, fibers of a melting point below 200° C. are desirable, while those of from 150 to 190° C. are more desirable, and those of from 150 to 170° C. are further desirable.

More specifically, polypropylene fibers, acrylic fibers, polyethylene fibers, vinylidene fibers and the like are conceivable. Among these, polypropylene fibers are desirable. These low-melting fibers may be used in a single kind or in a mixture of 2 or more kinds.

As for the compound fibers, the compound fibers composed of (a) the low-melting fibers and (b) fibers of a higher melting point than that of the low-melting fibers, particularly, a melting point of 170° C. or higher, selected from cellulose fibers, PET fibers, acrylic fibers, polyvinyl alcohol fibers, polyamide synthetic fibers, and the like are conceivable. Among these, the compound fibers containing polypropylene fibers are desirable, and more specifically, the compound fibers composed of polypropylene fibers and cellulose fibers, and the compound fibers composed of polypropylene fibers and PET fibers are desirable. These compound fibers may be used in a single kind or in a mixture of 2 or more kinds.

The form of the compound fibers is not specifically limited and compound fibers of, for example, a sheath-core type, a side-by-side type, a segmented-pie type, a sea-island type and a nebular type are conceivable.

In the chrysanthemum-shaped element of the present invention, when such compound fibers are used, the bonding sections at the top and bottom edges of inner surfaces of folds of the chrysanthemum-shaped element provide a heat-resistance performance.

The fibers with which the low-melting fiber layer is formed are desirable to be minute, and a diameter of fibers is desirable to be from 0.1 to 10 μm, while from 1 to 8 μm is more desirable, and from 1 to 6 μm is further desirable. The fiber diameter from 0.1 to 10 μm further improves the filter efficiency of the chrysanthemum-shaped element and extends the filter life longer.

The thickness of the low-melting fiber layer is desirable to be from 20 to 50% of that of the filter paper, while from 25 to 45% is more desirable, and from 30 to 40% is further desirable. The thickness of the low-melting fiber layer being from 20 to 50% of that of the filter paper ensures the bonding at the top edges and the bottom edges of inner surfaces of folds of the chrysanthemum-shaped element of the present invention. The filter efficiency of the chrysanthemum-shaped element is further improved and the filter life is extended longer.

In the chrysanthemum-shaped element of the present invention, it is desirable that the filter paper materials with which the filter paper is formed are at least one of cellulose fibers and polyethylene terephthalate fibers, and the fibers with which the low-melting fiber layer is formed are at least one of polypropylene fibers and compound fibers containing polypropylene fibers. In this case, the top edges and the bottom edges of inner surfaces of folds of the chrysanthemum-shaped element of the present invention are bonded more reliably.

The bonding sections above are formed at the top edges and the bottom edges of inner surfaces of folds of the chrysanthemum-shaped element of the present invention and are formed by heat-adhesion of the low-melting fiber layer which is formed on the surface of the filter paper.

The size of each bonding section at the top edges and the bottom edges of inner surfaces of the folds (also respectively called a top edge bonding section and a bottom edge bonding section, hereinafter) is adjusted in accordance with a required strength of the chrysanthemum-shaped element of a desired size. Particularly, the smaller the size of the bonding sections the more desirable. This is because the effective filtration area of a filter medium can be made larger as long as the strength of ensuring an adequate oil-tightness to prevent unfiltered oil to be leaked out is provided.

The specific dimensions of the top edge bonding section is, when the total length of the element body (length in an axial direction) is set as 100%, desirable to be formed up to a width of from 5 to 20% of the total length from the top edges of inner surfaces of the folds, while that of from 5 to 15% is more desirable, and that of from 5 to 10% is further desirable. The specific dimensions of the bottom edge bonding section is, when the total length of the element body (length in an axial direction) is set as 100%, desirable to be formed up to a width of from 5 to 20% of the total length from the bottom edges of inner surfaces of the folds, while that of from 5 to 15% is more desirable, and that of from 5 to 10% is further desirable.

Note that the size of the top edge boding section and the bottom edge bonding section may be of the same size or in different sizes. Particularly, in the present invention, the velocity of flow in the vicinity of an inlet for fluids such as oil in the fluid filter is higher compared with other sections and a heavy load is applied to a filter body. Therefore, as shown in FIG. 6, the size of the bottom edge bonding section 27b which is the inlet of fluids may be set larger than that of the top edge bonding section 27a to have the strength of the bottom edge bonding section 27b stronger than that of the top edge bonding section 27a.

In the chrysanthemum-shaped element of the present invention, other than the top edge bonding section and the bottom edge bonding section above, a provision of other bonding section by selectively heat-adhering the low-melting fiber layer which is formed at a section other than the top and bottom edges of inner surfaces of the folds improves the strength of the whole chrysanthemum-shaped element.

It is known that a flow velocity of fluids such as oil passing through a filter medium of a fluid filter is not even and the closer to an inlet and an outlet the higher the flow velocity. Therefore, by forming the other bonding section so as to make a flow distribution of fluids passing through the chrysanthemum-shaped element to be homogeneous, it is possible to improve the filter efficiency of the chrysanthemum-shaped element and to extend the filter life.

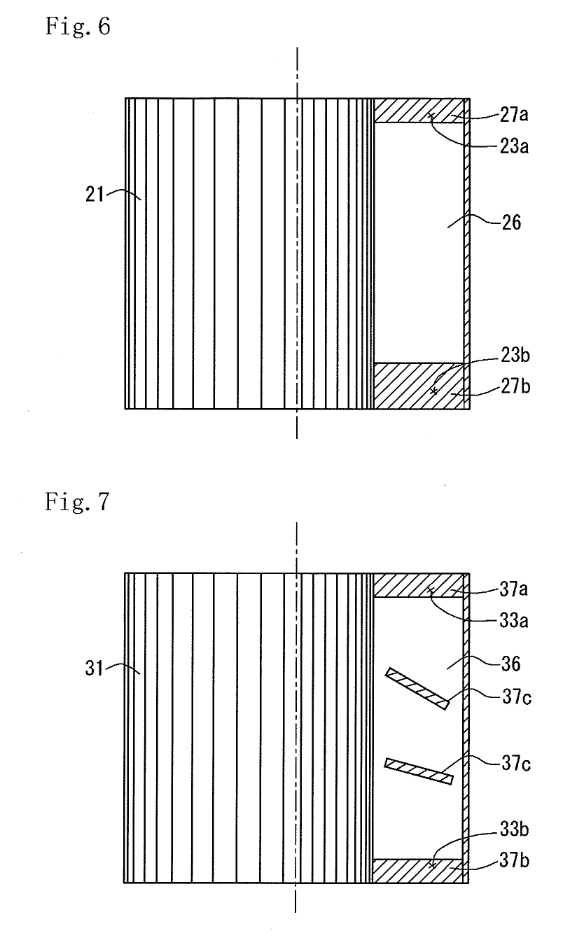

More specifically, the other bonding sections 37c with slants may be formed as shown in FIG. 7, so that the rectification effect can be obtained, that is, the fluids flow evenly on the upper side as well.

Note that the shape of the other bonding sections is not specifically limited. A single number of the other bonding section may be formed or a plurality of the other bonding sections may be formed as well. Further, the other bonding sections may be formed in all folds or only in a part of the folds.

### (2) Method for Manufacturing Chrysanthemum-Shaped Element

A method for manufacturing the chrysanthemum-shaped element of the present invention is a method for manufacturing the abovementioned chrysanthemum-shaped element. The method includes: a process of forming, on the surfaces of a filter paper at least at its top edge and bottom edge, a low-melting fiber layer composed of fibers of a lower melting point than that of filter paper materials with which the filter paper is formed and/or compound fibers containing fibers of a lower melting point than that of the filter paper materials (hereinafter called a low-melting fiber layer forming process); and a process of folding the filter paper on which the low-melting fiber layer is formed into a cylindrical chrysanthemum shape so that the surface on which the low-melting fiber layer is formed is to be on inner sides of folds and bonding the top edges and the bottom edges of the folds with heat-adhesion of the low-melting fiber layers by heating up the top edges and the bottom edges of the folds (hereinafter called a bonding process).

Note that for the descriptions of the filter paper, the fibers of a lower melting point than that of the filter paper materials (low-melting fibers) and the compound fibers containing fibers of a lower melting point than that of the filter paper materials (low-melting fibers) mentioned above, the aforementioned respective descriptions apply as is.

The shape of the filter paper in the low-melting fiber layer forming process above is, ordinarily, in a strip-shape and its dimensions are adjusted appropriately according to the chrysanthemum-shaped element of a desired size.

While the method for forming the low-melting fiber layer on the surface of the filter paper is not specifically limited, the use of a melt-blow method or a spunbond method is desirable, and particularly, the melt-blow method is desirable. The use of these methods makes it possible to easily form the low-melting fiber layer composed of fine fibers of a small diameter.

The low-melting fiber layer above is, while it is acceptable to be formed on a surface of the filter paper at least at its top edge and bottom edge by the abovementioned methods and such, desirable to be formed on the entire surface of the filter paper. When the low-melting fiber layer is formed on the entire surface of the filter paper, the low-melting fiber layer except for the areas where heat-adhesion is performed (bonding sections) serves as a filter medium. Accordingly, the filter efficiency of the chrysanthemum-shaped element produced is further improved and the filter life is extended longer.

The surface of the filter paper here refers to one side of the filter paper on the inner surface side of the folds of the chrysanthemum-shaped element produced. The top-and-bottom direction of the filter surface corresponds to the top-and-bottom direction of an axial direction of the chrysanthemum-shaped element produced.

The thickness of the low-melting fiber layer which is formed on the surface of the filter paper is desirable to be from 20 to 50% of that of the filter paper, while from 25 to 45% is more desirable, and from 30 to 40% is further desirable. The thickness of the low-melting fiber layer from 20 to 50% of that of the filter paper is desirable as the top edges and the bottom edges of inner surfaces of folds of the chrysanthemum-shaped element produced are reliably bonded.

In the bonding process above, the filter paper on which the low-melting fiber layer is formed is folded into a chrysanthemum shape so as to set the surface on which the low-melting fiber layer is formed to be on the inner side of folds of the filter medium, and thereafter top edges and bottom edges of the folds are heated from the outer side of the folds and the top edges and the bottom edges of the inner surface of folds are bonded by heat-adhesion of the low-melting fiber layers at the top edges and the bottom edges of inner surfaces of the adjacent folds.

In this process, when necessary, the other bonding sections of an appropriate shape are formed by heat-adhesion.

The size of the top edges of the folds that are thermally adhered to be the top edge bonding section is, when the total length of the element body (length in an axial direction) is set to 100%, desirable to be bonded up to a width of from 5 to 20% of the total length from the top edges of the folds, while that of from 5 to 15% is more desirable, and that of from 5 to 10% is further desirable.

The size of the bottom edges of the folds that are thermally adhered to be the bottom edge bonding section is, when the total length of the element body (length in an axial direction) is set to 100%, desirable to be bonded up to a width of from 5 to 20% of the total length from the bottom edges of the folds, while that of from 5 to 15% is more desirable, and that of from 5 to 10% is further desirable.

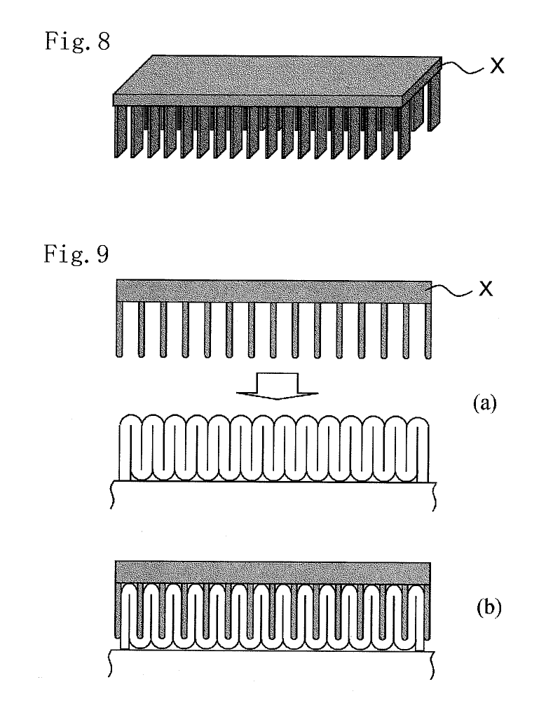

The method for heating the top and bottom edges of the above folds is not specifically limited, as long as the top edges and the bottom edges of the folds can be bonded. For example, as shown in FIG. 8, a heating jig which has a plurality of heating plates arranged at both ends may be used. Note that the position and size of the heating plates can be adjusted according to a desired size of the element and the number and the shape of the other bonding sections.

The heating temperature in the heat-adhesion is set at a temperature lower than a melting point of fibers with which the filter paper of the filter medium composed of the filter paper and the low-melting fiber layer is formed and higher than a melting point of the low-melting fibers with which the low-melting fiber layer of the filter medium composed of the filter paper and the low-melting fiber layer is formed. More specifically, heating at a temperature of from 160 to 230° C. is desirable, while from 170 to 220° C. is more desirable, and from 180 to 210° C. is further desirable.

The heating time is adjusted appropriately according to the heating temperature and the area of heat-adhesion, more specifically, a time from 1 to 30 seconds is desirable, while from 1 to 20 seconds is more desirable, and from 1 to 10 seconds is further desirable.

### (3) Filter Body

A filter body of the present invention includes the aforementioned chrysanthemum-shaped element and seal sections formed on a top surface and a bottom surface of the chrysanthemum-shaped element.

The seal sections are provided on the top surface and bottom surface of the chrysanthemum-shaped element, that is, on both ends of an axial direction of the chrysanthemum-shaped element. The shape, size, disposition pattern and such of the seal sections are not specifically limited, as long as space between a filter body and a casing which houses the filter body is securely sealed. Generally, the seal sections have a ring shape.

While the method for forming the seal sections is not specifically limited. For example, by applying a photo-curing resin on the top and bottom surfaces of the cylindrical chrysanthemum-shaped element, pressing a forming die and such as necessary, and by applying a predefined light irradiation, the seal sections of the desired shape are formed.

The photo-curing resin is, for example, a composition of a curable polymer (an uncured polymer, oligomer, etc.), mixed with a photopolymerization initiator, and is photopolymerized by a visible light, an ultraviolet, an electron beam, a neutron ray and the like. As for the photo-curing resin, for example, an acrylic-based resin, a silicone-based resin (a silicone polyester type and an acrylic silicone with acryloyl group and mercapto-vinyl addition polymerization type having an acryloyl group), an unsaturated polyester-based resin, an alkyd resin, an epoxy resin, a phenol resin, a polyimide resin, a fluorine resin, a urethane series resin, a polyether-based resin, a bismaleimide triazine resin, a guanamine resin, and a dicyclopentadiene resin may be used. These resins may be of a non-solvent type or a solvent type.

### (4) Fluid Filter

A fluid filter of the present invention includes the aforementioned filter body, a housing that houses the filter body, and a top support and a bottom support that are provided in the housing and that support the filter body in the upward and downward directions. The seal sections of the filter body seal the spaces between both end surfaces in the axial direction of the chrysanthemum-shaped element and the top and bottom supports.

### EMBODIMENTS

Here, embodiments of the present invention will be specifically described with reference to the drawings.

In the embodiments of the present invention, a spin-on type oil filter is described as an example of a fluid filter of the present invention. This oil filter is installed in a circuit of an engine lubrication system of a vehicle such as an automobile via an appropriate fixing device, and filters out foreign objects such as dusts, metallic wear fragments and sludge mixed into engine oil.

### First Embodiment

### (1) Oil Filter Structure

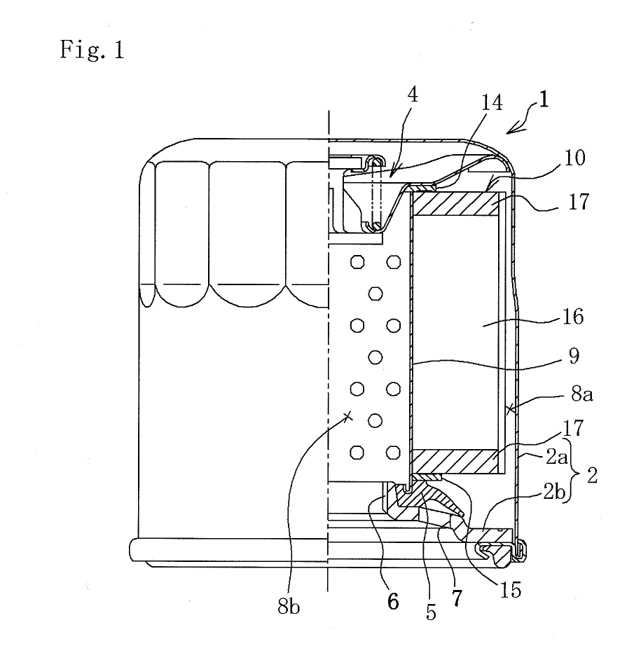

As shown in FIG. 1, an oil filter 1 of a first embodiment of the present invention includes: a casing 2 (shown as an example of a housing of the present invention); a filter body 10 housed in the casing 2; and a relief valve 4 (shown as an example of a top support of the present invention) and a check valve 5 (shown as an example of a bottom support of the present invention) that support the filter body 10 in the upward and downward directions.

The casing 2 is composed of a cylindrical casing member 2a for housing the filter body 10 and a bottom plate 2b that closes an opening formed at a bottom section of the casing member 2a. The bottom plate 2b is provided with a single piece of oil outlet 6 formed at its center as well as a plurality of oil inlets 7 formed surrounding the oil outlet 6 along its circumference at predetermined intervals. The later described seal sections which constitute the filter body 10 divide the space within the casing 2 into an oil passage 8a that connects to the oil inlets 7 to be an upstream of the filter body 10 and an oil passage 8b that connects to the oil outlet 6 to be a downstream of the filter body 10.

### (2) Filter Body Structure

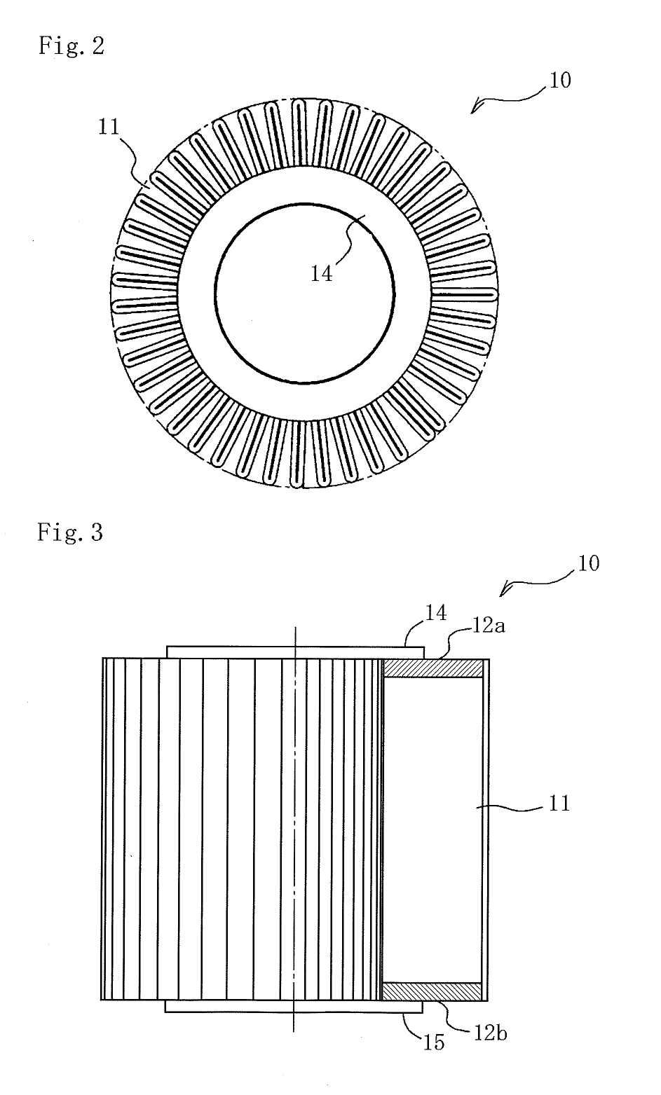

As shown in FIGS. 2 and 3, the filter body 10 of the first embodiment includes a cylindrical chrysanthemum-shaped element 11 and seal sections 14 and 15 that are formed at inner edges of a top surface 12a and a bottom surface 12b of the chrysanthemum-shaped element 11.

The seal sections 14 and 15 are formed with photo-curing resins such as an acrylic-based resin. The seal sections 14 and 15 have a predefined elastic force. When the filter body 10 is housed in the casing 2, the seal section 14 seals the space between the top surface of the filter body 10 and the relief valve 4, and the seal section 15 seals the space between the bottom surface of the filter body 10 and the check valve 5 (see FIG. 1).

### (3) Chrysanthemum-Shaped Element Structure

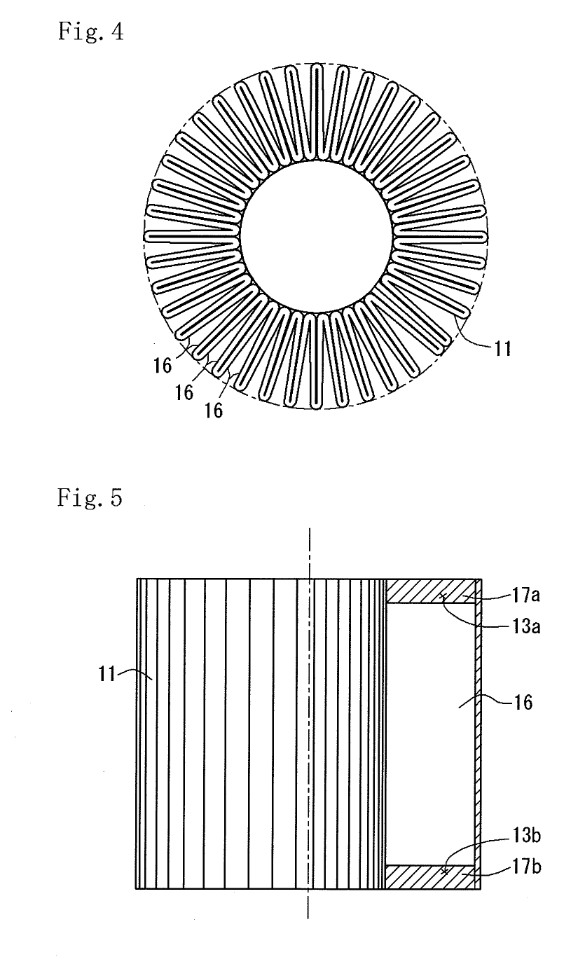

As shown in FIGS. 4 and 5, the cylindrical chrysanthemum-shaped element 11 of the first embodiment is formed by folding a strip-shaped filter medium into a chrysanthemum shape so that the filter medium has a number of folds 16. Top edges 13a and bottom edges 13b of inner surfaces of adjacent folds 16 are respectively bonded with a top edge bonding section 17a and a bottom edge bonding section 17b.

The filter medium includes a filter paper (thickness: approximately 0.8 mm) and a low-melting fiber layer (thickness: approximately 0.3 mm) which is formed on the entire surface of inner side of the folds 16 of the filter paper. The filter paper is composed of pulp fibers of a fiber diameter from 20 to 50 μm (decomposition point: approximately 180° C.) and PET fibers of a fiber diameter from 10 to 50 μm (melting point: approximately 260° C.), and the low-melting fiber layer is composed of polypropylene fibers of a fiber diameter from 1 to 3 μm (melting point: approximately 160° C.).

The top edge bonding section 17a is formed by heat-adhesion of the low-melting fiber layers which are formed on inner surfaces of adjacent folds 16 at their top edges 13a, and is formed, when the total length of the element body (length in an axial direction) is set as 100%, up to the width of 10% of the total length from the top edges of inner surfaces of the folds 16.

The bottom edge bonding section 17b is formed by heat-adhesion of the low-melting fiber layers which are formed on inner surfaces of adjacent folds 16 at their bottom edges 13b, and is formed, when the total length of the element body (length in an axial direction) is set as 100%, up to the width of 10% of the total length from the bottom edges of inner surfaces of the folds 16.

### (4) Method for Manufacturing Chrysanthemum-Shaped Element

First, as shown in FIGS. 4 and 5, a strip-shaped filter medium, i.e. a filter paper on which a low-melting fiber layer composed of polypropylene fibers is formed on the entire surface of inner sides of folds 16, is folded so as to form the folds 16. Next, a heating jig X (see FIG. 8) with a plurality of heating plates arranged at its both ends is inserted such that respective heating plates are wedged in between top edges of outer surfaces of the adjacent folds and in between bottom edges of outer surfaces of the adjacent folds, as shown in FIG. 9A. Then, the top edge bonding section 17a (see FIG. 5) and the bottom edge bonding section 17b (see FIG. 5) are formed by heat-adhesion of the low-melting fiber layers at the top edges 13a of the inner surfaces of the adjacent folds (see FIG. 5) and heat-adhesion of the low-melting fiber layers at the bottom edges 13b of the inner surfaces of the adjacent folds (see FIG. 5), respectively, by heating in a state as shown in FIG. 9B at 170° C. for 5 seconds. Next, by bonding both ends of the filter medium having the folds to form a cylindrical shape body, the chrysanthemum-shaped element 11 is produced.

### (5) Method for Manufacturing and Assembling Filter Body

The chrysanthemum-shaped element 11 (see FIGS. 4 and 5) formed as described in (4) Method for Manufacturing Chrysanthemum-shaped Element, is prepared. Next, a photo-curing resin is coated on the top surface of the chrysanthemum-shaped element 11 in the state that its axial direction is perpendicular. Then, from above the chrysanthemum-shaped element 11, a clear forming die is pressed against the coated photo-curing resin and, for approximately 30 seconds, an ultraviolet irradiation is applied. As a result, the seal section 14 is formed at the top surface 12a of the chrysanthemum-shaped element 11. In a similar manner to the top surface side, the seal section 15 is formed at the bottom surface 12b of the chrysanthemum-shaped element 11. Thus, the filter body 10 is produced.

In the filter body 10 produced as described above, a cylindrical metallic porous protector 9 (see FIG. 1) having a number of though-holes is attached to the inner circumference of the chrysanthemum-shaped element 11. The filter body 10 is housed in the casing member 2a and the bottom plate 2b is attached to the casing member 2a so as to produce the aforementioned oil filter 1.

### (6) Advantages of the First Embodiment

In the chrysanthemum-shaped element 11 of the first embodiment, the bonding sections 17a and 17b at the top edges and bottom edges of the folds 16 are formed by heat-adhesion of the low-melting fiber layers, as shown in FIG. 5. Therefore, it is possible to take full advantage of the original filtration area of the filter medium. Further, the low-melting fiber layer is formed on the entire surface of inner sides of the folds 16 and the low-melting fiber layer except for the top edge and bottom edge bonding sections 17a and 17b serves as a filter medium. Consequently, the filter efficiency of the chrysanthemum-shaped element is further improved and the filter life is extended longer.

The oil filter 1 and the filter body 10 of the first embodiment are superior in filter efficiency and filter life, as the aforementioned chrysanthemum-shaped element 11 is provided.

In the method for manufacturing the chrysanthemum-shaped element of the first embodiment, the low-melting fiber layer which is formed on the surface of the filter paper can be used as adhesives for inner surfaces of folds and the control of bonding area is easy. Therefore, the top edges and the bottom edges of the folds can be bonded in a bare minimum area and the chrysanthemum-shaped element having a large effective filtration area can be easily produced.

### Second Embodiment

In a second embodiment, an example in which a chrysanthemum-shaped element 21 shown in FIG. 6 is used in place of the chrysanthemum-shaped element 11 of the first embodiment will be described. Note that structures other than the chrysanthemum-shaped element 21 are the same as those in the first embodiment, and thus the explanation and the description of advantages relating to the other structures are omitted.

### (1) Chrysanthemum-Shaped Element Structure

The chrysanthemum-shaped element 21 of the second embodiment is formed by folding a strip-shaped filter medium into a chrysanthemum shape so as to have a number of folds 26, and top edges 23a and bottom edges 23b of inner surfaces of adjacent folds 26 are respectively bonded at their top edge bonding section 27a and bottom edge bonding section 27b, as shown in FIG. 6.

The filter medium includes a filter paper (thickness: approximately 0.8 mm) and a low-melting fiber layer (thickness: approximately 0.3 mm) which is formed on the entire surface of inner side of folds 26 of the filter paper. The filter paper is composed of pulp fibers of a fiber diameter from 20 to 50 μm (decomposition point: approximately 180° C.) and PET fibers of a fiber diameter from 10 to 50 μm (melting point: approximately 260° C.), and the low-melting fiber layer is composed of polypropylene fibers of a fiber diameter from 1 to 3 μm (melting point: approximately 160° C.).

The top edge bonding section 27a is formed by heat-adhesion of the low-melting fiber layers which are formed on inner surfaces of adjacent folds 26 at their top edges 23a and is formed, when the total length of the element body (length in an axial direction) is set as 100%, up to the width of 10% of the total length from the top edges of inner surfaces of the folds 26.

The bottom edge bonding section 27b is formed by heat-adhesion of the low-melting fiber layers which are formed on inner surfaces of adjacent folds 26 at their bottom edges 23b and is formed, when the total length of the element body (length in an axial direction) is set as 100%, up to the width of 20% of the total length from the bottom edges of inner surfaces of the folds 26.

### (2) Advantages of the Second Embodiment

In the chrysanthemum-shaped element 21 of the second embodiment, the bottom edge bonding section 27b is formed wider than the top edge bonding section 27a as shown in FIG. 6, because the bottom edge bonding section 27b is located in the vicinity of an inlet for fluids such as oil of a fluid filter where the velocity of flow is higher compared with other sections and receives a heavy load. Therefore, the chrysanthemum-shaped element 21 of the second embodiment has superior strength, and the life of the chrysanthemum-shaped element is further improved.

### Third Embodiment

In a third embodiment, an example in which a chrysanthemum-shaped element 31 shown in FIG. 7 is used in place of the chrysanthemum-shaped element 11 of the first embodiment will be described. Note that structures other than the chrysanthemum-shaped element 31 are the same as those in the first embodiment, and thus the explanation and the description of advantages relating to the other structures are omitted.

### (1) Chrysanthemum-Shaped Element Structure

The chrysanthemum-shaped element 31 of the third embodiment is formed by folding a strip-shaped filter medium into a chrysanthemum shape as to have a number of folds 36, and top edges 33a and bottom edges 33b of inner surfaces of adjacent folds 36 are respectively bonded at a top edge bonding section 37a and a bottom edge bonding section 37b as shown in FIG. 7. Each fold 36 is provided with other bonding sections 37c having predefined slants at two locations so as to have a rectification effect.

The filter medium includes a filter paper (thickness: approximately 0.8 mm) and a low-melting fiber layer (thickness: approximately 0.3 mm) which is formed on the entire surface of inner side of folds 36 of the filter paper. The filter paper is composed of pulp fibers of a fiber diameter from 20 to 50 μm (decomposition point: approximately 180° C.) and PET fibers of a fiber diameter from 10 to 50 μm (melting point: approximately 260° C.), and the low-melting fiber layer is composed of polypropylene fibers of a fiber diameter from 1 to 3 μm (melting point: approximately 160° C.).

The top edge bonding section 37a is formed by heat-adhesion of the low-melting fiber layers which are formed on inner surfaces of adjacent folds 36 at their top edges 33a and is formed, when the total length of the element body (length in an axial direction) is set as 100%, up to the width of 10% of the total length from the top edges of inner surfaces of the folds 36.

The bottom edge bonding section 37b is formed by heat-adhesion of the low-melting fiber layers which are formed on inner surfaces of adjacent folds 36 at their bottom edges 33b and is formed, when the total length of the element body (length in an axial direction) is set as 100%, up to the width of 10% of the total length from the bottom edges of inner surfaces of the folds 36.

Furthermore, the other bonding sections 37c are formed by heat-adhesion of the low-melting fiber layers of adjacent folds 36 at predefined locations.

### (2) Advantages of the Third Embodiment

In the chrysanthemum-shaped element 31 of the third embodiment, the other bonding sections 37c with predefined slants are formed on each of the folds 36 so as to make the flow distribution of fluids such as oil passing through the filter medium homogeneous, as shown in FIG. 7. Therefore, it is possible to further improve the filter efficiency of the chrysanthemum-shaped element. In addition, the strength of the whole chrysanthemum-shaped element can be further improved by using the other bonding sections 37c.

The present invention is not limited to the aforementioned embodiments and various modifications may be made within the spirit and scope of the present invention according to the uses and purposes. For example, while the embodiments are for filtering oil, the use is not limited to filtering of oil and the present invention may be applicable for filtering an air and such.

While the structures of the oil filter in the embodiments are of a so-called spin-on type oil filter, the structure of the oil filter is not limited to this.

The chrysanthemum-shaped element and the method for manufacturing the same, the filter body and the fluid filter of the present invention is widely applicable in the fields of fluid filters such as an oil filter used for automobiles and the like and of gas filters such as an air filter used as a component of an air cleaner installed in an inlet system of an internal-combustion engine.

What is claimed is:

1. A chrysanthemum-shaped element in a cylindrical shape in which folds are formed and inner surfaces of adjacent folds are bonded at a top edge and a bottom edge thereof, said chrysanthemum-shaped element comprising:
(A) an element body composed of a filter medium;
said filter medium comprising:
a filter paper; and
a low-melting fiber layer formed on a surface of said filter paper on the inner surface side of said folds at least at said top edge and said bottom edge of said filter paper; and
(B) bonding sections formed at said top and bottom edges on the inner surfaces of said folds by heat-adhesion of said low-melting fiber layer;
wherein said low-melting fiber layer is formed of at least one of a fiber of a lower melting point than that of a filter paper material with which said filter paper is formed and compound fibers containing a fiber of a lower melting point than that of said filter paper material.

2. The chrysanthemum-shaped element according to claim 1, wherein said low-melting fiber layer is formed on the entire surface of said filter paper on the inner surface side of said folds.

3. The chrysanthemum-shaped element according to claim 1, wherein the diameter of said fiber with which said low-melting fiber layer is formed is from 0.1 to 10 μm.

4. The chrysanthemum-shaped element according to claim 1, wherein the thickness of said low-melting fiber layer is from 20 to 50% of that of said filter paper.

5. The chrysanthemum-shaped element according to claim 1, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

6. The chrysanthemum-shaped element according to claim 2, wherein the diameter of said fiber with which said low-melting fiber layer is formed is from 0.1 to 10 μm.

7. The chrysanthemum-shaped element according to claim 2, wherein the thickness of said low-melting fiber layer is from 20 to 50% of that of said filter paper.

8. The chrysanthemum-shaped element according to claim 2, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

9. The chrysanthemum-shaped element according to claim 3, wherein the thickness of said low-melting fiber layer is from 20 to 50% of that of said filter paper.

10. The chrysanthemum-shaped element according to claim 3, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

11. The chrysanthemum-shaped element according to claim 4, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

12. The chrysanthemum-shaped element according to claim 6, wherein the thickness of said low-melting fiber layer is from 20 to 50% of that of said filter paper.

13. The chrysanthemum-shaped element according to claim 6, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

14. The chrysanthemum-shaped element according to claim 7, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

15. The chrysanthemum-shaped element according to claim 9, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

16. The chrysanthemum-shaped element according to claim 12, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.

17. A method for manufacturing a chrysanthemum-shaped element according to claim 1, the method comprising:
forming, on a surface of a filter paper at least at a top edge and a bottom edge thereof, a low-melting fiber layer composed of at least one of a fiber of a lower melting point than that of a filter paper material with which said filter paper is formed and compound fibers containing a fiber of a lower melting point than that of said filter paper material; and
folding said filter paper on which said low-melting fiber layer is formed into a cylindrical chrysanthemum shape so that the surface of said filter paper on which said low-melting fiber layer is formed is on inner sides of folds, and bonding said top edge and said bottom edge of said folds with heat-adhesion of said low-melting fiber layer by heating up said top edge and said bottom edge of said folds.

18. The method for forming a chrysanthemum-shaped element according to claim 17, wherein in forming said low-melting fiber layer, at least one of a melt-blow method and a spunbond method is used to form said low-melting fiber layer on the surface of said filter paper.

19. A filter body comprising:
said chrysanthemum-shaped element according to claim 1; and
seal sections formed on a top surface and a bottom surface of said chrysanthemum-shaped element.

20. A fluid filter comprising:
said filter body according to claim 19;
a housing that houses said filter body; and
a top support and a bottom support that are provided in said housing and that support said filter body in the upward and downward directions;
wherein seal sections of said filter body seal spaces between both end surfaces in an axial direction of said chrysanthemum-shaped element of said filter body and said top support and said bottom support.

21. The fluid filter according to claim 20, wherein said low-melting fiber layer is formed on the entire surface of said filter paper on the inner surface side of said folds.

22. The fluid filter according to claim 20, wherein the diameter of said fiber with which said low-melting fiber layer is formed is from 0.1 to 10 μm.

23. The fluid filter according to claim 20, wherein the thickness of said low-melting fiber layer is from 20 to 50% of that of said filter paper.

24. The fluid filter according to claim 20, wherein said filter paper material with which said filter paper is formed is at least one of a cellulose fiber and a polyethylene terephthalate fiber, and said fiber with which said low-melting fiber layer is formed is at least one of a polypropylene fiber and compound fibers containing a polypropylene fiber.
